(19) United States
(12) Patent Application Publication
(10) Pub. No.: US 2004/0214614 A1
(43) Pub. Date: Oct. 28, 2004

(54) Mobile phone and hands-free kit with inductive link

(76) Inventor: James Edward Aman, Chichester (GB)

Correspondence Address: BAKER & BOTTS, 30 ROCKEFELLER PLAZA, NEW YORK, NY, 10112

(21) Appl. No.: 10/486,308

(22) PCT Filed: Aug. 6, 2002
(86) PCT No.: PCT/GB02/03611

(30) Foreign Application Priority Data
Aug. 7, 2001 (GB) 01191972

(51) Int. Cl. H04Q 7/20

(52) U.S. Cl. 455/569.1; 455/575.2

(57) ABSTRACT

A mobile phone has a transmitter coil forming a first part of an inductive link for forwarding sound signals received by the mobile phone and an earpiece for fitting into an ear canal and having a housing of which at least a proximal portion can fit within the ear canal. The housing contains a receiver coil forming a second part of the inductive link for receiving sound signals from the transmitter, an amplifier for amplifying the sound signals received by the receiver coil, a transducer for reproducing the received sound signals; and a space for a battery. The amplifier has means responsive to received signal level for squelching its output at low levels of detected signal.

### FIELD OF THE INVENTION

The present invention relates to a mobile phone operable hands-free using an earpiece that fits at least partly into the ear canal, and to a hands-free kit for a mobile phone as aforesaid.

### BACKGROUND TO THE INVENTION

Hands-free kits for mobile phones are known, but generally speaking wires or a cable connect the phone to the earpiece or earpieces.

In the field of auditory prostheses it is known e.g. from U.S. Pat. No. 4,532,930 to provide inductive loop coupling between a wearable speech processor to be worn e.g. in a shirt pocket and a receiver-stimulator to be implanted in the patient's ear. The above specification also discloses that a squelch circuit should be provided so as to disable the receiver when there is only background noise and to enable it in response to an incoming relatively high intensity speech signal.

Various amplifier circuits for hearing aids are known; see U.S. Pat. Nos. 3,487,324, 3,469,200 and 4,085,382, aimed at minimizing idle current and at the same time minimizing distortion. Class H amplifiers for use in hearing aids are available as hybrids from Gennum Corporation.

### SUMMARY OF THE INVENTION

It is an object of the invention to provide means that provides a wireless hands-free kit for a mobile phone that is inconspicuous and of good sound quality.

In one aspect the invention provides a mobile phone having a transmitter coil forming a first part of an inductive link for forwarding sound signals received by the mobile phone and an earpiece for fitting into an ear canal and having a housing of which at least a proximal portion can fit within the ear canal, said housing containing:

a receiver coil forming a second part of the inductive link for receiving sound signals from the transmitter;

an amplifier for amplifying the sound signals received by the receiver coil;

a transducer for reproducing the received sound signals; and

a space for a battery;

wherein the amplifier has means responsive to received signal level for squelching its output at low levels of detected signal.

In a further aspect the invention provides a kit for hands-free operation of a mobile phone comprising:

a transceiver unit for plug connection to the mobile phone and having a transmitter coil for forming a first part of an inductive link for forwarding sound signals received by the mobile phone and a microphone for sound signals to be supplied to the mobile phone; and

an earpiece for fitting into an ear canal and having a housing of which at least a proximal portion can fit within the ear canal, said housing containing:

a receiver coil for forming a second part of the inductive link for receiving sound signals from the transmitter;

an amplifier for amplifying the sound signals received by the receiver coil;

a transducer for reproducing the received sound signals; and

a space for a battery,

wherein the amplifier has means responsive to received signal level for squelching its output at low levels of detected signal.

Other preferred features of the invention will be apparent from the accompanying claims to which attention is directed.

### BRIEF DESCRIPTION OF THE DRAWINGS

An embodiment of the invention will now be described, by way of example only, with reference to the accompanying drawings, in which:

FIG. 1 shows schematically a mobile phone, wireless hands-free unit and receiver and earpiece unit;

FIG. 2. shows the circuits for the transmitter unit;

FIG. 3 shows the receiver circuit in block diagram form; and

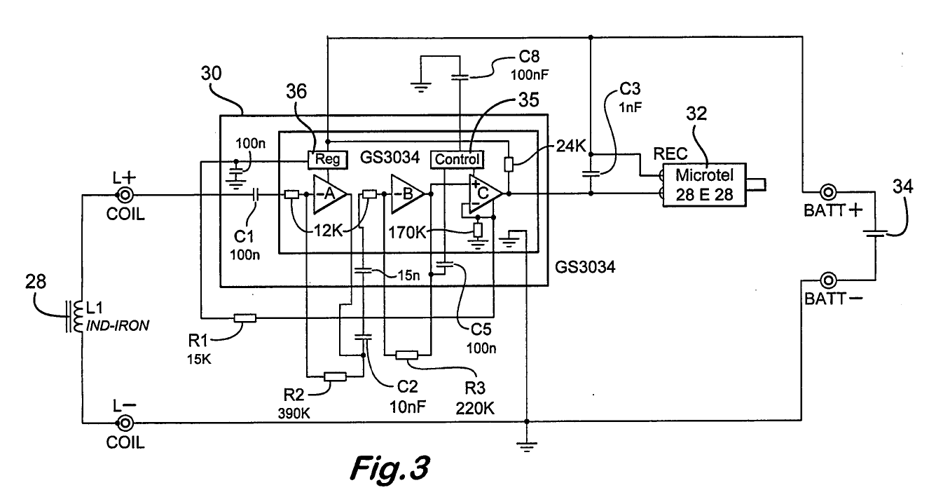

FIG. 4 is a more detailed receiver circuit diagram.

### DETAILED DESCRIPTION OF PREFERRED EMBODIMENT

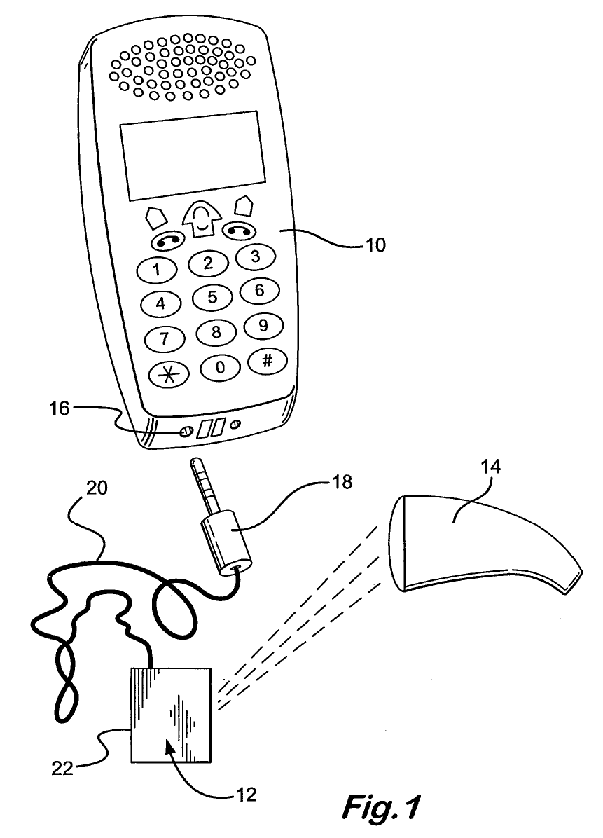

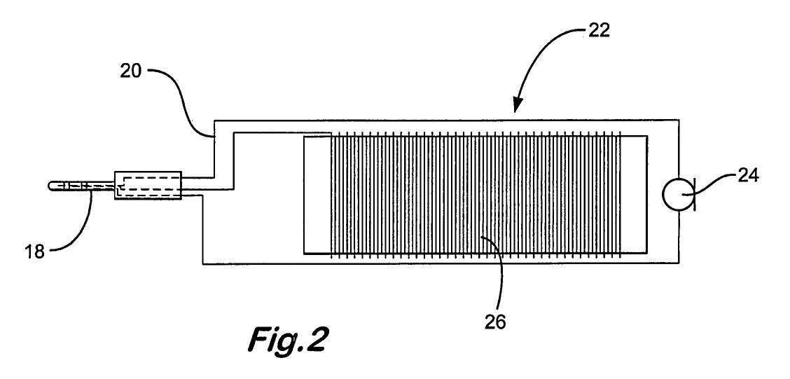

In FIG. 1, apparatus for making a hands-free telephone call comprises a mobile phone 10, a wireless hands-free unit 12 and an earpiece unit 14 which may be a behind the ear device, an in-the ear device or an in-the canal device for fitting into the auditory canal. An in-the canal device is preferred on the grounds of cosmetic appeal, use of the natural acoustic properties of the auditory canal and enhancement of sound in the 24 kHz region. The phone 10 is of conventional construction and has a socket 16 for receiving plug 18 of the hands-free unit that is connected by a cable 20 of length typically about 0.7 m (2 ft) to a body 22. As is apparent from FIG. 2 the hand-free unit body may be attached to e.g. a jacket lapel of the user's clothing and includes an electret microphone 24 for picking up the user's speech and a loop transmitter coil 26 for transmitting incoming audio that has been received by the phone.

The earpiece unit 14 houses a pick-up coil 28, a class H amplifier generally indicated by the reference numeral 30, a transducer 32 and a battery 34. The amplifier is in the form of a hybrid, for example that sold by Gennum Corporation under the designation GS3034. The signal from coil 28 is AC coupled via C1 to first low-noise inverting preamplifier A whose output is AC coupled to second low-noise inverting preamplifier B via capacitor C2. Resistors R2 and R3 control the gain of respective amplifiers A and B. The output from preamplifier B is fed to a current drive output stage C with frequency shaping via a capacitor C3 connected across the transducer 32. A bias control 35 sets the voltage delivered by the power supply to the output stage C so that a voltage is applied during periods of low volume and a higher voltage is applied during periods of high volume, whereby drain on the battery 34 is reduced. A resistor R1 supplies a voltage from regulator 36 to emitters of transistors in the output stage C acts as a noise gate or squelch and inactivates the output stage C under no-signal conditions. In this way current drain is further reduced and annoying and/or potentially harmful noise is not transmitted to the ear of the wearer in a no-signal state or when an incoming signal begins or ends.

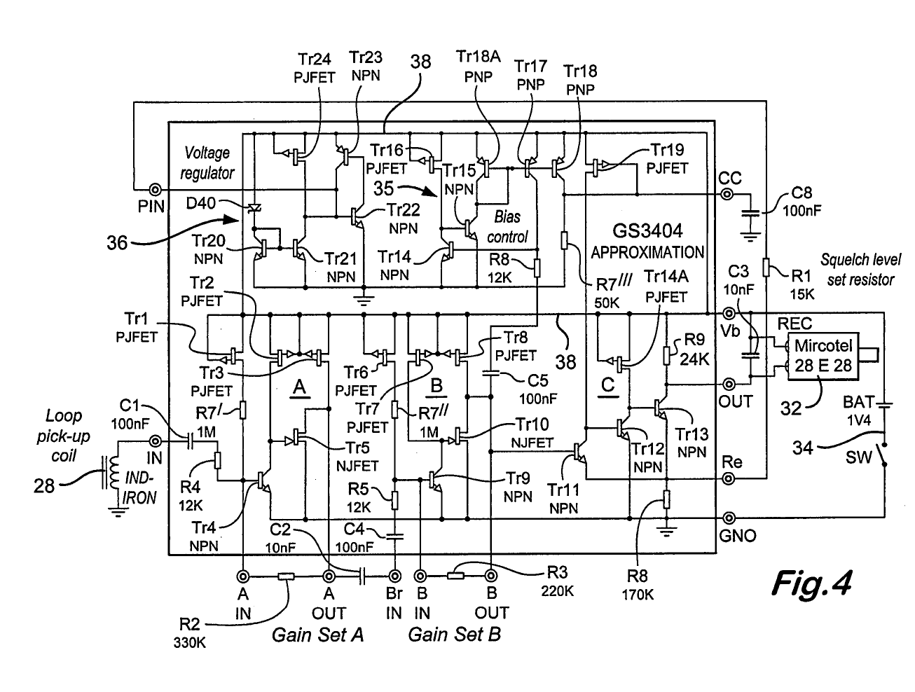

In FIG. 4 one side of coil 28 is AC coupled via capacitor C1 and resistor R4 to the base of NPN transistor Tr4. Its base is also connected to the drain of PJFET Tr1 whose source is connected to positive rail 38, the PJFET being configured to act as a high impedance constant current source. The collector of Tr4 is connected to the gate of NJFET Tr5 and also to the source of TR2 whose drain is connected to rail 38, Tr2 also being configured to act as a current source. The drain of Tr3 is connected to rail 38 and its source is connected to the source of Tr5 whose drain is connected to the emitter of TR4. Tr4 and Tr5 act effectively as a NPN transistor with a common collector and a high collector resistance, giving an open loop gain of >35 db. Feedback resistor R2 is connected between the source of Tr5 and the base of Tr4 and with R4 sets the gain of pre-amplifier A. The output is AC coupled via C2 whose value is relatively low to reduce mains hum, and through series capacitor C4 and resistor R5 to the base of NPN transistor Tr9 of pre-amplifier B. In that pre-amplifier, PJFETs Tr6, Tr7 and Tr8, NPN transistor TR9 and NJFET TR10 are connected and operate in the same way as their counterparts in pre-amplifier A, the gain being controlled by the ratio of R3 to R5. The gain of pre-amplifier B is less than that of pre-amplifier A to reduce amplification of circuit noise.

The signal from pre-amplifier B is fed to bias control 35 via capacitor C5 and resistor R6 so that the voltage at the base of NPN transistor Tr14 changes depending on the signal level. The emitter of Tr14 is grounded and the collector is connected firstly to the source of PJFET Tr16 whose drain is connected to positive rail 38 and secondly to the base of NPN transistor Tr15. Tr14 controls the current through NPN transistor Tr15 which lowers or raises the base voltage of PNP transistors Tr16A, Tr17 and Tr18 whose emitters are connected to the positive rail 38. The collector of Tr16A is connected to ground through the collector and emitter of Tr15. Tr17 and Tr18 are arranged as a current mirror with the collector of Tr17 being connected to ground through the base and emitter of Tr14 and with the collector of Tr18 being connected to ground via R7. The junction of Tr18 and R7 is also connected to capacitor C6 and to the gate of PJFHT Tr19 whose drain is connected to the positive rail 38 and whose source is connected to the collector of Tr11 and to the base of Tr12. Tr19 acts as a voltage controlled current source which monitors the voltage on C6 which in turn controls the current through Tr19 and hence the gain and bias level of power stage C to provide bias to collector of Tr11 and the base of Tr12. There is therefore a programmable current going into that junction with a time constant determined by the R-C time constant of R7 and C6. In the low signal state relatively low bias current is fed to the junction which is a minimum to pass the signal cleanly, whereas in a high signal state the bias current increases and output stage C behaves as a traditional class A amplifier.

Output stage C is a three-transistor amplifier whose output is fed to the transducer 32. The signal passes from pre-amplifier B to power stage C by direct coupling, as previously noted, to the base of transistor Tr11 whose emitter is connected to ground through resistor R8 which responds to increasing emitter current in Tr11 and Tr13 by developing a voltage thereacross that lifts both the emitter and base voltages and so provides negative feedback. The collector of transistor TR12 is connected to PJFET transistor Tr14A, which acts as a current source, and its emitter is grounded. The signal from Tr12 is directly coupled from the junction of its emitter with the source of Tr14A into the base of NPN output transistor Tr13. The collector of Tr13 is connected via load resistor R9 to rail 38 and its emitter is connected via R8 to ground. The output is taken across load resistor R9 with shaping by C3 as previously noted.

Transistors Tr20-24 and Schottky diode 40 are configured as a voltage regulator having an output connected to one side of resistor R1 whose other side is connected to the junction of R8 with the emitters of Tr11 and Tr13. The effect of the voltage applied through R1 is to increase the voltage developed across R8 which in the low signal state squelches the output stage C. When a higher intensity signal is encountered, the amplified signal through C5 and R6 causes the bias control 35 to increase the current fed into the junction of Tr11 and Tr12.

The present circuit gives the output stage C characteristics that are desirable in this application of a relatively short attack time determined by the dynamic impedance of the collector of Tr11 and a longer decay time terminating in an abrupt squelch rather than a liner decay. Because of the abrupt attack, speech input is not significantly clipped when a signal arrives, because of the decay time clipping of the trailing part of a speech signal is avoided. Furthermore the output stage remains active and is free of spurious noise during the decay time and then is abruptly and substantially noiselessly squelched, thereby offering the maximum intelligible signal with little objectionable interference. In the above circuit the attack time is of the order of 1 ms and can be about 2-3 milliseconds to reach near full amplitude, which should be fast enough to capture any complete word. An attack time of up to 10 ms will generally be fast enough to avoid missing anything meaningful, and 2-3 ms is long enough to ensure circuit stability. The decay time is only a function of battery life and may be 5 ms or more and is typically a few seconds to avoid the circuit from changing gain too frequently and thus causing annoying breathing sounds during speech.

It will be appreciated that modifications may be made to the embodiment described above without departing from the invention. For example, the squelch resistor R1 could be connected to rail 38 rather than to the output of voltage regulator 36, but the latter is preferred because the voltage is somewhat more stable. Although the description has been with reference to a single earpiece, the phone could be used with a pair of earpieces in order to give a more natural perception to the received sound.

1. A mobile phone having a transmitter coil forming a first part of an inductive link for forwarding sound signals received by the mobile phone and an earpiece for fitting into an ear canal and having a housing of which at least a proximal portion can fit within the ear canal, said housing comprising:
a receiver coil forming a second part of the inductive link for receiving sound signals from the transmitter;
an amplifier for amplifying the sound signals received by the receiver coil, the amplifier having a means responsive to received signal level for squelching its output at low levels of detected signal;
a transducer for reproducing the received sound signals; and
a space for a battery.

2. The phone of claim 1, wherein the squelching means is arranged so that the amplifier has a short attack time on arrival of a detected signal and a decay time at the end of a detected signal that is a multiple of the attack time.

3. The phone of claim 2, wherein the squelching means is arranged to operate abruptly at the end of the decay time.

4. The phone of claim 3, wherein the squelching means is arranged to be disabled in an attack time determined by the dynamic impedance of a collector forming part of a power stage of the amplifier.

5. The phone of claim 4, wherein the decay time is determined by the R-C time constant of a resistor and capacitor arranged to be fed with the received signal.

6. The phone of claim 1 wherein the amplifier is of class H.

7. A mobile phone having a transmitter coil forming a first part of an inductive link for forwarding sound signals received by the mobile phone and an earpiece for fitting into an ear canal, said phone being constructed and arranged to operate substantially as hereinbefore described with reference to the accompanying drawings.

8. A kit for hands-free operation of a mobile phone comprising:
a transceiver unit for plug connection to the mobile phone and having a transmitter coil for forming a first part of an inductive link for forwarding sound signals received by the mobile phone and a microphone for sound signals to be supplied to the mobile phone; and
an earpiece for fitting into an ear canal and having a housing of which at least a proximal portion can fit within the ear canal, said housing containing:
a receiver coil for forming a second part of the inductive link for receiving sound signals from the transmitter;
an amplifier for amplifying the sound signals received by the receiver coil, the amplifier having a means responsive to received signal level for squelching its output at low levels of detected signal;
a transducer for reproducing the received sound signals; and
a space for a battery.

9. (Cancelled)

10. A mobile phone having a hands-free kit including means for transmitting received sound between the phone and an earpiece through a magnetic induction link.

11. The phone of claim 2 wherein the amplifier is of class H.

12. The phone of claim 3 wherein the amplifier is of class H.

13. The phone of claim 4 wherein the amplifier is of class H.

14. The phone of claim 5 wherein the amplifier is of class H.
